(19) United States
(12) Patent Application Publication
(10) Pub. No.: US 2007/0204410 A1
(43) Pub. Date: Sep. 6, 2007

(54) Method For Optical Brightening Of Synthetic Fibres Or Of Synthetic Fibres Mixed With Natural Fibres

(75) Inventors: Karl Siemensmeyer, Frankenthal (DE); Dieter Weber, Hassloch (DE); Andrea Misske, Speyer (DE); Heinz Heissler, Frankenthal (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/592,096

(22) PCT Filed: Mar. 9, 2005
(86) PCT No.: PCT/EP05/02496

§ 371 Date: Sep. 7, 2006

(30) Foreign Application Priority Data
Mar. 11, 2004 (DE) 10 2004 011 957.0

(51) Int. Cl. C11D 3/00

(52) U.S. Cl. 8/115.51

(57) ABSTRACT

The present invention relates to a process for optical brightening of synthetic fibers or of synthetic fibers in a blend with natural fibers by treatment in a treatment bath to which a microemulsion was added and which as well as water comprises the components to be brightened. The microemulsion comprises nonionic surfactants, ionic surfactants, organic solubilizers and water.

The present invention relates to a process for optical brightening of synthetic fibers or of blends of synthetic fibers with natural fibers, which comprises treating the synthetic fibers or blends of synthetic fibers with natural fibers in a treatment bath which comprises optical brighteners and to which a microemulsion was added.

Numerous compounds, known as optical brighteners, are known for their ability to endow textiles or plastics with a white color.

EP 0 023 026 discloses compounds of the general formula I

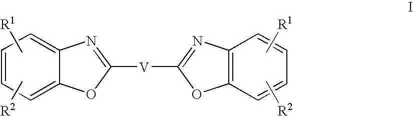

where R¹ and R² may be for example H, F, Cl, phenyl, CF₃, alkyl or numerous other radicals and where V is selected from

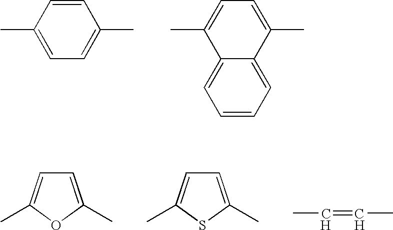

A disadvantage with the use of compounds of the general formula I as optical brighteners is that their yield at low temperature is limited, i.e., a lot of product is needed to achieve the desired brightening effect.

Also known is a process for optical brightening of textiles wherein the textiles are treated with distyrylbenzene compounds known from CH-A 366 512 for example.

EP-A 0 023 027 and EP-B2 0 032 917 and also the references cited in EP-B2 0 030 917 disclose the use of mixtures of two or more dicyanostyrylbenzene compounds for optical brightening of polyesters.

DE 102 19 993 A1 concerns a process for brightening of textile materials which utilizes compounds of the general formula I, a dicyanostyrylbenzene compound and a compound of the general formula II

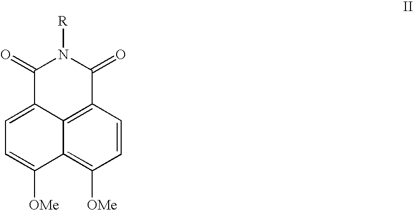

where R is selected from C₄₋₁₀-alkyl.

The optical brightening of textile materials is generally effected by the exhaust process or by the thermosol process.

In the thermosol process, the textile material to be brightened is customarily padded with an aqueous liquor comprising the optically brightening substances, if appropriate a blue or violet shading dye or mixtures thereof and if appropriate additives (see above). The wet pickup is generally in the range from 30% to 100%. Thereafter, the textile material is dried and set/fixed at 150 to 200° C. for 5 to 60 seconds. The disadvantage with the thermosol process is that the setting/fixing temperature of from 150 to 210° C. and especially from 170 to 190° C. demands high energy requirements. These high setting/fixing temperatures may cause any additives or contaminants adhering to the textile material due to previous treatment steps to fume off and lead to gaseous emissions. Despite the high temperatures, the thermosol process achieves no more than ring brightening, which is inferior to the whiteness of an exhaust dyeing. In the case of blends of manufactured fibers with natural fibers or with synthetic cellulosic fibers, browning of the natural fiber or synthetic cellulosic fiber can occur.

A further known process is the exhaust process, which is usually carried out in aqueous liquor at 90 to 135° C.

In the exhaust process, the textile material to be brightened is generally introduced at 10 to 50° C. into an aqueous liquor which comprises the optically brightening compounds, if appropriate a blue or violet shading dye or a mixture thereof and if appropriate additives, for example dispersants, carboxylic acids or bases, and whose pH is usually in the range from 3 to 12 and preferably in the range from 3 to 8. The liquor ratio (weight ratio of liquor: textile material) is in the range from 1.5:1 to 40:1, preferably in the range from 5:1 to 20:1. The bath is then heated in the course of 15 to 60 minutes to a temperature in the range from 95 to 135° C. and maintained at that temperature for 15 to 60 minutes. Thereafter, the brightened textile material is rinsed and dried.

Polyester or polyester blends will typically be brightened using the high temperature (HT) process. To sufficiently exceed the dyeing transition temperature of polyester, the brightening operation has to be carried out at around 130° C. in order that a commercially adequate brightening effect may be achieved. Since brightening takes place in an aqueous medium, the operation has to be carried out in an autoclave, a high pressure apparatus or a high pressure machine. Disadvantages include that such an assembly is more costly than an open assembly, that the heating and cooling time and thus machine occupancy is long and that the energy required, especially for heating to 130° C., is very high.

In the carrier process, the brightening liquor has carriers added to it which lower the dyeing transition temperature by around 30° C.

Carriers are frequently formulations based on emulsifiers, occasionally solvents and the active component. Active components are compounds based on liquid halogenated benzene derivatives, alkyl aromatic compounds, aromatic hydroxy compounds, aromatic alcohols, ketones, carboxylic acids and esters thereof, alkylphthalimides or substituted phenyl glycols and esters thereof. The most important active components are 1,2-dichlorobenzene, 1,2,4-trichlorobenzene, 2-phenylphenol, biphenyl, diphenyl ether, methyl benzoates, butyl benzoates, benzyl benzoates, methyl salicylates, dimethyl phthalates, N-butylphthalimides or chlorophenoxyethanol.

The carrier process provides excellent white effects within a short brightening time at a lower brightening temperature and hence lower energy consumption. However, carriers can lead to spotting. Moreover, carriers are often cancer-causing.

A low temperature process has been developed as an alternative to the carrier process. The low temperature process utilizes mixtures of ionic and nonionic surfactants with aliphatic or aromatic dicarboxylic acids instead of utilizing carcinogenic carriers. These mixtures are not fiber active, but they do enhance the solubility of brighteners in the dyeing liquor and thereby permit brightening at 98 to 110° C. The mixtures of ionic and nonionic surfactants with aliphatic or aromatic dicarboxylic esters are also known as diffusion accelerants because they accelerate the diffusion of brighteners from the dyeing liquor into the fiber.

The process has some disadvantages. Diffusion accelerants transition a gel phase on dilution, and this impairs homogeneous distribution in the brightening bath. The resulting whiteness is inferior to that of a carrier brightening. The white effect decreases rapidly at brightening temperatures below 100° C. While acceptable white effects are still achieved at 98° C., the resulting whiteness at 95° C. is insufficient for many requirements. But open assemblies used in the textile-finishing industry are often unable to attain temperatures above 95° C. in the aqueous medium.

The present invention has for its object to provide a brightening process which can be carried out in open assemblies, which provides excellent whitenesses, which is free of toxic or carcinogenic assistants, which avoids liquor inhomogeneities (especially due to gel phases of surfactants) and which achieves excellent white effects at temperatures as low as around 95° C.

We have found that this object is achieved according to the present invention by a process for optical brightening of synthetic fibers or of blends of synthetic fibers with natural fibers, which comprises treating the synthetic fibers or blends of synthetic fibers with natural fibers in a treatment bath which comprises optical brighteners and to which a microemulsion was added. Such microemulsions are already being used as leveling assistants in the dyeing of polyester in textile form. Dyeings of polyester in textile form are frequently unlevel, nonuniform, spotty. Such unlevelnesses can be controlled by adding microemulsions to the dyeing solutions. The added microemulsion stabilizes the disperse particles of dye and directs the molecular process of transportation to the fiber and the process of the dye molecules becoming dissolved in the polyester fiber. It is a further office of the microemulsion to direct the diluting involved in setting the dye liquor such that no high-viscosity interim states come about.

Unlevelnesses typically do not arise in the optical brightening of synthetic textile materials, i.e., cannot be detected by the naked eye. Textile assistants having leveling effects are therefore not required in optical brightening, nor used in commercial practice. Microemulsions have no leveling effect in the optical brightening of synthetic fiber materials, but they do act as diffusion accelerants in that the setting/fixing temperature required in the case of polyester, for example, can be lowered by about 35° C. from about 130° C. to about 95° C. without any noticeable reduction in the whiteness achieved.

The microemulsion which can be used according to the present invention comprises nonionic surfactants, ionic surfactants, organic solubilizers and water.

More particularly, the microemulsion which can be used according to the present invention comprises the following components:
(a) as component A 1-40% by weight of a compound formed by a reaction of a compound a1 of the general formula III

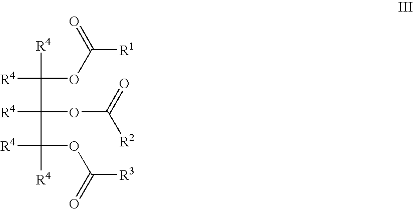

where R¹, R² and R³ are independently an aliphatic, aromatic or araliphatic radical;

preferably R¹, R² and R³ are branched or unbranched, saturated, aliphatic radicals having 1-40 carbon atoms or branched or unbranched, unsaturated, aliphatic radicals having 2-40 carbon atoms which may each be substituted by one or more functional groups selected from the group consisting of hydroxyl group, ether group, amino group, thio group, aldehyde group, keto group, carboxylic acid group, ester group, amido group and halogen;

more preferably R¹, R² and R³ are independently partly unsaturated, aliphatic radicals having 10-25 carbon atoms which may be substituted by at least one hydroxyl and/or amino group;

most preferably all of R¹, R² and R³ are —(CH₂)₇—CH═CH—CH₂—CH(OH)—(CH₂)₄CH₃, wherein the double bond is preferably in the cis configuration;

and each R⁴ is independently hydrogen or an aliphatic radical having 1-15 carbon atoms, an aromatic radical having 6-15 carbon atoms or an araliphatic radical having 7-15 carbon atoms, preferably R⁴ is hydrogen or a linear or branched, saturated, aliphatic radical having 1 to 10 carbon atoms or a linear or branched, unsaturated, aliphatic radical having 2-10 carbon atoms, most preferably R⁴ is hydrogen;

with a compound a2 of the general formula IV

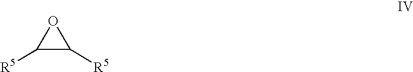

where each R⁵ is independently hydrogen or aliphatic radical having 1-15 carbon atoms, aromatic radical having 6-15 carbon atoms or araliphatic radical having 7-15 carbon atoms, preferably R⁵ is hydrogen or a linear or branched, saturated, aliphatic radical having 1 to 10 carbon atoms or a linear or branched, unsaturated, aliphatic radical having 2-10 carbon atoms, most preferably each R⁵ is independently hydrogen, methyl, ethyl or propyl;
(b) as component B 1-25% by weight of a compound formed by a reaction of a compound b1 of the general formula V

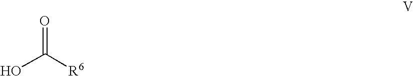

where R⁶ is an aliphatic, aromatic or araliphatic radical;

preferably R⁶ is a branched or unbranched, saturated, aliphatic radical having 1-40 carbon atoms or a branched or unbranched, unsaturated, aliphatic radical having 2-40 carbon atoms which may be substituted by one or more functional groups selected from the group consisting of hydroxyl group, ether group, amino group, thio group, aldehyde group, keto group, carboxylic acid group, ester group, amido group and halogen;

more preferably R⁶ is a partly unsaturated, aliphatic radical having 10-25 carbon atoms which may be substituted by at least one hydroxyl and/or amino group;

most preferably R⁶ is —(CH₂)₇—CH═CH—CH₂—CH(OH)—(CH₂)₄CH₃, wherein the double bond is preferably in the cis configuration;

with a compound b2 of the general formula VI

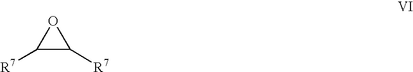

where each R⁷ is independently hydrogen or aliphatic radical having 1-15 carbon atoms, aromatic radical having 6-15 carbon atoms or araliphatic radical having 7-15 carbon atoms, preferably R⁷ is hydrogen or a linear or branched, saturated, aliphatic radical having 1-10 carbon atoms or a linear or branched, unsaturated, aliphatic radical having 2-10 carbon atoms, most preferably each R⁷ is independently hydrogen, methyl, ethyl or propyl;
(c) as component C 1-15% by weight of a compound of the general formula VII

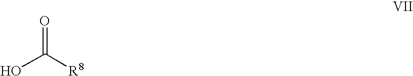

where R⁸ is an aliphatic, aromatic or araliphatic radical;

preferably R⁸ is a branched or unbranched, saturated, aliphatic radical having 1-40 carbon atoms or a branched or unbranched, unsaturated, aliphatic radical having 2-40 carbon atoms which may be substituted by one or more functional groups selected from the group consisting of hydroxyl group, ether group, amino group, thio group, aldehyde group, keto group, carboxylic acid group, ester group, amido group and halogen;

more preferably R⁸ is a partly unsaturated, aliphatic radical having 10-25 carbon atoms which may be substituted by at least one hydroxyl and/or amino group;

most preferably R⁸ is —(CH₂)₇—CH═CH—(CH₂)₇CH₃, wherein the double bond is preferably in the cis configuration;
(d) as component D 1-40% by weight of a compound of the general formula VIII

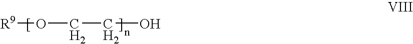

where R⁹ is an aliphatic, aromatic or araliphatic radical;

preferably R⁹ is a branched or unbranched, saturated, aliphatic radical having

1-12 carbon atoms or a branched or unbranched, unsaturated, aliphatic radical having 2-12 carbon atoms which may be substituted by one or more functional groups selected from the group consisting of hydroxyl group, ether group, amino group, thio group, aldehyde group, keto group, carboxylic acid group, ester group, amido group and halogen;

more preferably R⁹ is a saturated, aliphatic radical having 1-6 carbon atoms which may be substituted by at least one hydroxyl and/or amino group;

most preferably R⁹ is selected from the group consisting of ethyl, n-propyl, n-butyl and n-pentyl;

the average value of n in the formula VIII is an integral or fractional positive number from 1 to 10, preferably from 1 to 8 and more preferably from 1 to 5; when mixtures of the compounds of the general formula VIII are present, the average value of n can assume 15 fractional values.
(e) as component E 1-50% by weight of a compound of the general formula IX

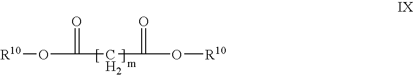

where R¹⁰ is an aliphatic, aromatic or araliphatic radical;

preferably R¹⁰ is a branched or unbranched, saturated, aliphatic radical having 1-12 carbon atoms or a branched or unbranched, unsaturated, aliphatic radical having 2-12 carbon atoms which may be substituted by one or more functional groups selected from the group consisting of hydroxyl group, ether group, amino group, thio group, aldehyde group, keto group, carboxylic acid group, ester group, amido group and halogen;

more preferably R¹⁰ is a saturated, aliphatic radical having 1-6 carbon atoms which may be substituted by at least one hydroxyl and/or amino group;

most preferably R¹⁰ is selected from the group consisting of ethyl, n-propyl, n-butyl and n-pentyl;

the average value of m in the formula IX is an integral or fractional positive number from 0 to 10, preferably from 0 to 8 and more preferably from 0 to 5; when mixtures of the

compounds of the general formula IX are present, the average value of m can assume fractional values

and 1-40% by weight of water as a solvent, the sum total of the weight % being 100% by weight.

The components A, B, C, D and E are preferably present in the microemulsion in the following fractions:
component A: 5-35% by weight,
component B: 5-20% by weight,
component C: 1-10% by weight,
component D: 5-35% by weight,
component E: 5-40% by weight

and 5-35% by weight of water as a solvent, the sum total of the weight % being 100% by weight.

More preferably, the components A, B, C, D and E are present in the microemulsion in the following fractions:
component A: 10-30% by weight,
component B: 5-15% by weight,
component C: 2-8% by weight,
component D: 10-30% by weight,
component E: 10-35% by weight

and 10-30% by weight of water as a solvent, the sum total of the weight % being 100% by weight.

The microemulsion which can be used according to the present invention can be prepared by mixing the appropriate components in any desired order.

An advantage of the microemulsion used according to the present invention is its low viscosity at any mixing ratio with water. The product is thus readily usable in metering equipment. The microemulsion is absolutely transparent. The oil phase present, in addition to the aqueous phase, is thus so finely dispersed in the microemulsion that there is no detectable optical scattering.

The average size of the droplets in the disperse phase of the microemulsion used according to the present invention can be determined by the principle of quasi-elastic dynamic light scattering (the so-called z-average droplet diameter d_{z} of the unimodal analysis of the autocorrelation function).

The droplet size of the microemulsions used according to the present invention is ≦500 nm for d_{z}. Preferably, d_{z} is in the range from 50 nm to 300 nm and more preferably in the range from 50 nm to 200 nm.

The process of the present invention makes it possible to achieve optical brightening of polyesters, polyamides or blends between polyesters, between polyamides or else blends of polyesters or polyamides with other synthetic or natural fibers.

Examples of other synthetic or natural fibers are cellulosic fibers, polyacrylonitrile fibers, polyurethane fibers, acetate fibers or wool fibers.

The process of the present invention is particularly useful for optical brightening of polyester fibers or of blends of polyester fibers.

The term “polyester” as used herein comprehends homopolymers, copolymers, blends and grafts of synthetic long-chain polyesters consisting essentially of repeating ester groups in the polymer main chain.

In one embodiment of the process according to the present invention the polyesters used according to the present invention are formed from aromatic or aliphatic hydroxy carboxylic acids. The aliphatic hydroxy carboxylic acids used in the polyesters of the present invention are C₁₋₁₂-carboxylic acids which, as well as the COOH group, additionally contain at least one OH group and may be substituted by C₁₋₈-alkyl chains. The C₁₋₈-alkyl chains mentioned may be substituted by further functional groups. Preference is given to hydroxy carboxylic acids selected from the group consisting of 2-hydroxyacetic acid, 2-hydroxypropionic acid, 3-hydroxypropionic acid, 4-hydroxybutyric acid, 5-hydroxypentanoic acid, 6-hydroxyhexanoic acid, malic acid, tartaric acid and citric acid. The aromatic or aliphatic hydroxy carboxylic acids which can be used according to the present invention contain 7 to 20 carbon atoms and at least one hydroxy functionality, and preferably it is ortho-, meta- or para-hydroxybenzoic acid which is used in the polyesters which can be used according to the present invention.

In a further embodiment of the process according to the present invention the polyesters which can be used comprise diacids and diols.

The diacids incorporated in the polyesters of the present invention can be aliphatic or aromatic diacids having 4 to 18 carbon atoms. Preference is given to dicarboxylic acids selected from the group consisting of phthalic acid, terephthalic acid, isophthalic acid, naphthalene-1,4-dicarboxylic acid, naphthalene-2,3-dicarboxylic acid, naphthalene-2,6-dicarboxylic acid, cyclohexanedicarboxylic acid, cyclohexanediacetic acid, biphenyl-4,4-dicarboxylic acid, succinic acid, glutaric acid, adipic acid, azelaic acid and sebacic acid or mixtures thereof.

The diacids incorporated in the polyester are more preferably selected from terephthalic acid or naphthalic diacid or a mixture thereof.

The diols incorporated in the polyester which can be used according to the present invention can be cycloaliphatic diols having 6 to 20 carbon atoms or aliphatic diols having 2 to 20 carbon atoms. Preferably, the diol incorporated in the polyester is selected from the group consisting of ethylene glycol, diethylene glycol, triethylene glycol, 1,4-cyclohexanedimethanol, propane-1,3-diol, butane-1,4-diol, pentane-1,5-diol, hexane-1,6-diol, 2-methylpentane-1,4-diol, 2,2,4-trimethylpentane-1,3-diol, hexane-1,3-diol, 2,2-bis(4-hydroxycyclohexyl)propane and 2,4-dihydroxy-1,1,3,3-tetramethylcyclobutane or mixtures thereof.

In a preferred embodiment the polyester which can be used according to the present invention comprises ethylene glycol as diol component.

In a particularly preferred embodiment of the present invention the polyesters used are homopolymers of polyethylene terephthalate (PET) or mixtures of polyethylene terephthalate with further polyesters.

The molecular weight of the polyesters which can be used according to the present invention is preferably in the range from 2000 to 50 000 g/mol. The polyesters which can be used according to the present invention can be present in any possible linear density and also in any possible form, i.e., as staple, fiber, yarn, thread, weave, knit or nonwoven.

The polyesters used according to the present invention are produced by processes known to one skilled in the art, see Encycl. Polym. Sci. Engng. 12, 1 to 313 and Houben-Weyl E20/2, 1405 to 1429, Ullmann (4th) 19, 61 to 88.

Useful optical brighteners for the process of the present invention include optical brightener compounds already known per se, for example from Ullmann's Encyclopedia of Industrial Chemistry, 5th edition, volume A18, pages 156 to 161.

The process of the present invention is very useful for optical brightening of polyester fibers based on PET or of blends of PET with other synthetic or natural fibers.

The optical brighteners utilized in the process of the present invention are preferably 1,4-bisdicyanostyrylbenzenes of the general formula X

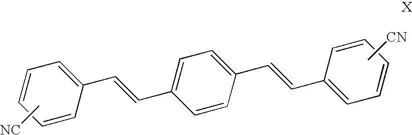

or 1,4-bisdicyanostyrylbenzenes of the general formula X in admixture with each other or with other optical brighteners which are free of ionic groups, or compounds of the general formula I or compounds of the general formula I in admixture with other optical brighteners which are free of ionic groups.

Compounds of the general formula I are known from EP 0 023 026. All compounds disclosed therein are compounds of the general formula I which can be used in the process of the present invention.

The process of the present invention can utilize all possible isomers of 1,4-bisdicyanostyrylbenzenes of the formula X, for example ortho-ortho, ortho-meta, ortho-para, meta-meta, meta-para, para-para or mixtures of two or more.

It may be particularly preferable to employ the ortho-para isomer, the ortho-meta isomer or the meta-para isomer or mixtures of two or three or all isomers with each other or mixtures of one, two or all three isomers with the ortho-ortho isomers or with a compound of the general formula I in the process of the present invention.

The process of the present invention generally has optical brighteners and shading dyes being applied as aqueous preparations.

Such preparations generally comprise water and (each percentage being based on the weight of the preparation) from 1% to 40% by weight, preferably from 2% to 25% by weight and more preferably from 3% to 10% by weight of the above-specified mixture of brightener and shading dye and also from 1% to 60% by weight, preferably from 3% to 56% by weight and more preferably from 5% to 52% by weight of assistants.

Useful assistants include for example anionic or nonionic dispersants from the class of the ethylene oxide adducts with fatty alcohols, higher fatty acids or alkylphenols or ethylenediarnine-ethylene oxide-propylene oxide adducts or dispersants as described in DE-A-2 745 449, copolymers of N-vinylpyrrolidone with 3-vinylpropionic acid, water-retaining agents such as ethylene glycol, glycerol or sorbitol or biocides.

A preferred method of working utilizes a brightener preparation comprising (each percentage being based on the weight of the preparation) from 1% to 40% by weight, preferably from 2% to 25% by weight and more preferably from 3% to 10% by weight of the above-specified mixture of brightener and shading dye, from 1% to 30% by weight, preferably from 2% to 20% by weight and more preferably from 3% to 12% by weight of anionic or nonionic dispersant and from 1% to 50% by weight, preferably from 1% to 35% by weight and more preferably from 1% to 25% by weight of further assistants (examples being water-retaining agents or biocides) as well as water.

The treatment bath, comprising optical brighteners, may comprise shading dyes.

Useful shading dyes for the purposes of the present invention generally come from the class of the disperse, acid or vat dyes. These are customary designations. The Colour Index lists such dyes for example as Disperse Blue or Disperse Violet or Acid Blue or Acid Violet or Vat Blue or Vat Violet.

Blue dyes from the class of the anthraquinones, azo dyes, methine dyes, violanthrones or indanthrones are particularly useful.

The process of the present invention utilizes an aqueous treatment bath comprising optical brighteners which comprises the following ingredients:
from 0.001% to 1.00% by weight, preferably from 0.01% to 0.75% by weight and more preferably from 0.01% to 0.50% by weight of the brightener preparation described, and
from 0.1 to 5 g/l, preferably from 0.3 to 3 g/l and more preferably from 0.5 to 1.5 g/l of the microemulsion described.

The process of the present invention is carried out at a temperature in the range from 80 to 120° C., preferably in the range from 90 to 110° C. and more preferably in the range from 95 to 100° C.

The process of the present invention is carried out for a period in the range from 10 to 300 min, preferably for a period in the range from 20 to 200 min and more preferably for a period in the range from 30 to 120 min.

The present invention further provides for the use of the present invention's treatment bath, comprising optical brighteners, for optical brightening of synthetic fibers or of blends of synthetic fibers with natural fibers.

The present invention also provides a treatment bath, to which a microemulsion according to the invention was added, for synthetic fibers or for synthetic fibers in admixture with natural fibers, comprising water and optical brighteners with or without shading dyes.

The present invention further provides for the use of the microemulsion according to the present invention in treatment baths comprising optical brighteners for synthetic fibers or synthetic fibers in admixture with natural fibers.

### EXAMPLES

### Example 1

In an autoclave, 100 ml of a brightening bath comprising 0.04 g of a brightener dispersion were entered with 10 g of woven polyester fabric at 25° C. The brightener dispersion comprises the following optical brighteners:

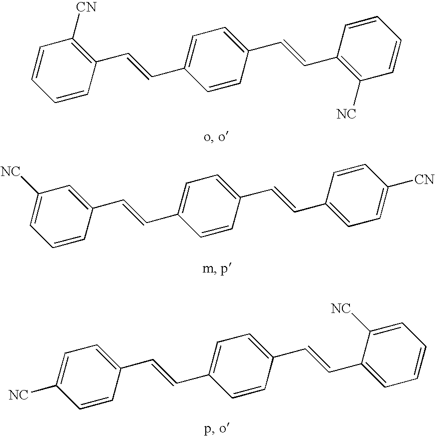

in the weight fractions of 4% for m,p′, 4% for p,o′ and at 2% for o,o′, plus dispersant for the optical brighteners and water. The individual brightener components had been separately finished and subsequently mixed. The bath was then heated to 95° C. over 30 min and maintained at 95° C. for 30 min. All the while, the liquor is stirred. Thereafter, the fabric is removed from the bath, rinsed and dried. For analysis, the CIE whitenesses were determined.

No further assistants were added in run 1.

Run 2 utilized a common diffusion accelerant 1 added at 0.7 g/l.

Run 3 utilized a further common diffusion accelerant 2, likewise added at 0.7 g/l.

Run 4 utilized 0.7 g/l of a microemulsion according to the present invention, which is described hereinbelow.

Diffusion accelerant 1 is a mixture consisting of an oleic acid ethoxylate incorporating 5 EO units (50% by weight) and n-butyl succinate (50% by weight).

Diffusion accelerant 2 is a mixture consisting of an oleic acid ethoxylate incorporating 5 EO units (45% by weight), di-n-butyl phthalate (30%) and an oleic acid ethoxylate incorporating 12 EO units.

These two diffusion accelerants are low-viscosity liquids which form highly viscous states on dilution with water. These products are consequently not suitable for state-of-the-art metering systems.

Composition (in % by weight) of microemulsion used according to invention:

| | |
|---|---|
| Castor oil ethoxylated with 40 EO | 20 |
| Oleic acid ethoxylated with 5 EO | 10 |
| Oleic acid | 5 |
| Butyldiglycol | 20 |
| Di-n-butyl glutarate | 25 |
| Water | 20 |

The microemulsion used according to the present invention is prepared by mixing the components in the appropriate amounts, the order of addition of the individual components having no bearing on the performance of the microemulsion.

The resulting whitenesses are as follows:

| | |
|---|---|
| No assistant | 128 |
| Diffusion accelerant 1 | 128.5 |
| Diffusion accelerant 2 | 128 |
| Microemulsion | 133 |

CIE whiteness differences of 3 units or more are visually detectable and thus must be deemed a technical advantage.

### Example 2

In an autoclave, 100 ml of a brightening bath comprising 0.04 g of a brightener dispersion were entered with 10 g of a knit polyester fabric at 25° C. The brightener dispersion comprises the optical brightener recited in example 1 in the weight fractions of 4% for m,p′, 4% for p,o′ and 2% for o,o′. The balance is dispersant and water. The individual brightener components had first been separately finished and subsequently mixed. The bath was then heated to 90° C. over 30 min and maintained at 90° C. for 30 min. All the while, the liquor is stirred. Thereafter, the knit was removed from the bath, rinsed and dried. For analysis, CIE whitenesses were determined.

The resulting whitenesses are as follows:

| | |
|---|---|
| No assistants | 130 |
| Diffusion accelerant 1 | 132 |
| Diffusion accelerant 2 | 133 |
| Microemulsion | 136 |

### Example 3

In an autoclave, 100 ml of a brightening bath comprising 0.04 g of a brightener dispersion were entered with 10 g of polyester staple fiber yarn at 25° C. The brightener dispersion comprises the following optical brighteners:

as for example 1

in the weight fractions of 6% for p,o′ and 4% for o,o′. The balance is dispersant and water. The individual brightener components had first been separately finished and subsequently mixed. The bath was then heated to 95° C. over 30 min and maintained at 95° C. for 30 min. All the while, the liquor is stirred. Thereafter, the staple fiber yarn was removed from the bath, rinsed and dried. For analysis, CIE whitenesses were determined.

The resulting whitenesses are as follows:

| | |
|---|---|
| No assistants | 131 |
| Diffusion accelerant 1 | 134 |
| Diffusion accelerant 2 | 134 |
| Microemulsion | 137 |

### Example 4

In an autoclave, 100 ml of a brightening bath comprising 0.04 g of a brightener dispersion were entered with 10 g of knit 50% polyester-50% viscose fabric at 25° C. The brightener dispersion comprises the following optical brighteners:

as for example 1

in the weight fractions of 10% for m,p′. The balance is dispersant and water. The individual brightener components had first been separately finished and subsequently mixed. The bath was then heated to 98° C. over 30 min and maintained at 98° C. for 30 min. All the while, the liquor is stirred. Thereafter, the knit was removed from the bath, rinsed and dried. For analysis, CIE whitenesses were determined.

The resulting whitenesses are as follows:

| | |
|---|---|
| No assistants | 132 |
| Diffusion accelerant 1 | 134 |
| Diffusion accelerant 2 | 135 |
| Microemulsion | 138 |

### Example 5

In an autoclave, 100 ml of a brightening bath comprising 0.25 g of a brightener dispersion were entered with 10 g of polyester staple fiber yarn at 25° C. The brightener dispersion comprises the following optical brighteners:

as for example 1

in the weight fractions of 10% for o,o′. The balance is dispersant and water. The individual brightener components had first been separately finished and subsequently mixed. The bath was then heated to 100° C. over 45 min and maintained at 100° C. for 30 min. All the while, the liquor is stirred. Thereafter, the staple fiber yarn was removed from the bath, rinsed and dried. For analysis, CIE whitenesses were determined.

The resulting whitenesses are as follows:

| | |
|---|---|
| No assistants | 123 |
| Diffusion accelerant 1 | 124 |
| Diffusion accelerant 2 | 124 |
| Microemulsion | 132 |

1. A process for optical brightening of synthetic fibers or of blends of synthetic fibers with natural fibers, which comprises treating the synthetic fibers or blends of synthetic fibers with natural fibers in a treatment bath which comprises optical brighteners and to which a microemulsion was added, wherein the microemulsion comprises the following components:
(a) as component A 1-40% by weight of a compound formed by a reaction of a compound a1 of the general formula III 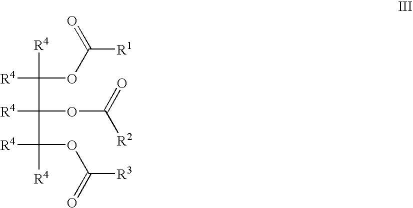
where R¹, R² and R³ are independently an aliphatic, aromatic or araliphatic radical which may each be substituted by one or more functional groups selected from the group consisting of hydroxyl group, ether group, amino group, thio group, aldehyde group, keto group, carboxylic acid group, ester group, amido group and halogen;
and each R⁴ is independently hydrogen or an aliphatic radical having 1-15 carbon atoms, an aromatic radical having 6-15 carbon atoms or an araliphatic radical having 7-15 carbon atoms,
with a compound a2 of the general formula IV 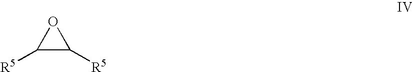
where each R⁵ is independently hydrogen or aliphatic radical having 1-15 carbon atoms, aromatic radical having 6-15 carbon atoms or araliphatic radical having 7-15 carbon atoms;
(b) as component B 1-25% by weight of a compound formed by a reaction of a compound b1 of the general formula V 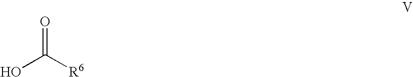
where R⁶ is an aliphatic, aromatic or araliphatic radical which may be substituted by one or more functional groups selected from the group consisting of hydroxyl group, ether group, amino group, thio group, aldehyde group, keto group, carboxylic acid group, ester group, amido group and halogen;
with a compound b2 of the general formula VI 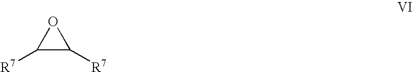
where each R⁷ is independently hydrogen or aliphatic radical having 1-15 carbon atoms, aromatic radical having 6-15 carbon atoms or araliphatic radical having 7-15 carbon atoms;
(c) as component C 1-15% by weight of a compound of the general formula VII 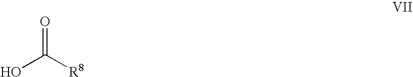
where R⁸ is an aliphatic, aromatic or araliphatic radical;
(d) as component D 1-40% by weight of a compound of the general formula VIII 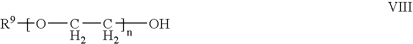
where R⁹ is an aliphatic, aromatic or araliphatic radical and the average value of n is an integral or fractional positive number from 1-10;
(e) as component E 1-50% by weight of a compound of the general formula IX 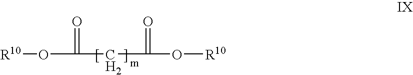
where R¹⁰ is an aliphatic, aromatic or araliphatic radical and the average value of m is an integral or fractional positive number from 0 to 10;
and water as a solvent, the sum total of the weight % of components A, B, C, D and E and also water as a solvent being 100% by weight.

2. The process according to claim 1 conducted at a temperature in the range from 80 to 120° C.

3. The process according to claim 1 wherein polyesters, polyamides or blends of polyesters or polyamides with each other or with other synthetic or natural fibers are optically brightened.

4. The process according to claim 1 wherein the microemulsion comprises nonionic surfactants, ionic surfactants, organic solubilizers and water.

5. The process according to claim 1 wherein the treatment bath which comprises optical brighteners comprises shading dyes.

6. The method of using a treatment bath which comprises optical brighteners and is as defined in claim 1 for optical brightening of synthetic fibers or of blends of synthetic fibers with natural fibers.

7. A treatment bath to which a microemulsion according to claim 1 was added, for synthetic fibers or for synthetic fibers in a blend with natural fibers, comprising water and optical brighteners with or without shading dyes.

8. The method of using a microemulsion as defined in claim 1 in treatment baths comprising optical brighteners, for synthetic fibers or for synthetic fibers in a blend with natural fibers.
